(19) United States
(12) Patent Application Publication
(10) Pub. No.: US 2024/0002117 A1
(43) Pub. Date: Jan. 4, 2024

(54) PACKAGING SEAL AND ENCLOSURE

(71) Applicant: Lenovo (Singapore) Pte. Ltd., New Tech Park (SG)

(72) Inventors: Robert J. Kapinos, Durham, NC (US); Scott Li, Cary, NC (US); Russell Speight VanBlon, Raleigh, NC (US); Robert James Norton, JR., Raleigh, NC (US)

(21) Appl. No.: 17/855,005

(22) Filed: Jun. 30, 2022

(51) Int. Cl. B65D 65/40; B32B 7/12; B32B 7/06

(52) U.S. Cl. CPC B65D 65/40; B32B 7/12; B32B 7/06; B32B 2307/581; B32B 2435/02

(57) ABSTRACT

Apparatuses, methods, and systems are disclosed for a packaging seal and packaging enclosure. An apparatus includes a packaging seal having a thickness with a top surface and a bottom surface, a length having a proximal end and a distal end, and a width in a direction orthogonal to the length. The apparatus further includes a protective layer having a first adhesive layer substantially covering a bottom surface of the protective layer, and a seal layer having an anchor portion attached to a top surface and a proximal end of the protective layer, a cutting portion extending from the anchor portion to a flap portion, and the flap portion extending from the cutting portion toward the distal end of the packaging seal and having a second adhesive layer substantially covering a bottom surface of the flap portion.

### FIELD

The subject matter disclosed herein relates to packaging seals and more particularly relates to a security and protective sticker seal and packaging enclosure.

### BACKGROUND

Devices, products (e.g., electronics), or the like are often packaged for production, storage, and distribution using seals adhered to a packaging enclosure. At times in the distribution process, sealed packages may need to be opened for further processing of the packaged product and then resealed. To prevent unauthorized tampering during manufacturing, distribution, and storage, package seals are often designed to be difficult, if not impossible, to remove without destroying the seal and the packaging enclosure. If not properly opened at any stage or if improperly resealed during distribution or storage, the product may get damaged. For example, cutting the packaging enclosure or seal with a razor knife might scratch or damage the product or its accessories. Likewise, if the packaging enclosure is mangled, it may allow contaminates to enter or destroy the product during subsequent shipping or storage.

### BRIEF SUMMARY

Apparatuses, methods, and systems are disclosed for improving packaging seals and enclosures. An apparatus, in one embodiment, includes a packaging seal having a thickness with a top surface and a bottom surface, a length having a proximal end and a distal end, and a width in a direction orthogonal to the length, further comprising a protective layer having a first adhesive layer substantially covering a bottom surface of the protective layer and a seal layer having an anchor portion attached to a top surface and a proximal end of the protective layer, a cutting portion extending from the anchor portion to a flap portion; the flap portion extending from the cutting portion toward the distal end of the packaging seal and having a second adhesive layer substantially covering a bottom surface of the flap portion.

A method, in one embodiment, includes removing a first removable film from a bottom surface of a packaging seal, adhering the bottom surface of the packaging seal to a packaging enclosure, removing a second removable film from a flap portion of a seal layer of the packaging seal, and adhering the flap portion to an end portion of the packaging enclosure.

A method, in another embodiment, includes cutting through a seal layer of a first packaging seal that is affixed to an original packaging enclosure without cutting through a lower protective layer of the first packaging seal, removing a first removable film from a bottom surface of a second packaging seal, adhering the bottom surface of the second packaging seal to the original packaging enclosure, removing a second removable film from a flap portion of a seal layer of the second packaging seal, and adhering the flap portion to an end portion of the original packaging enclosure.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be limiting of scope, the embodiments will be described and explained with additional specificity and detail using the accompanying drawings, in which:

FIG. 1a is a schematic block diagram illustrating a side view of one embodiment of a packaging seal;

FIG. 1b is a schematic block diagram illustrating a side view of one embodiment of a packaging seal and packaging enclosure;

FIG. 2a is a schematic block diagram illustrating a side view of another embodiment of a packaging seal and packaging enclosure;

FIG. 2b is a schematic block diagram illustrating a side view of an alternative embodiment of a packaging seal and packaging enclosure;

FIG. 3 is a schematic block diagram illustrating a side view of yet another embodiment of a packaging seal and packaging enclosure;

FIG. 4 is a schematic flow chart diagram illustrating one embodiment of a method for applying a packaging seal to a packaging enclosure; and

FIG. 5 is a schematic flow chart diagram illustrating one embodiment of a method for breaking one packaging seal and applying another packaging seal to an original packaging enclosure.

### DETAILED DESCRIPTION

As will be appreciated by one skilled in the art, aspects of the embodiments may be embodied as a system or method. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, structures, or characteristics of the embodiments may be combined in any suitable manner. In the following description, numerous specific details are provided. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment.

The apparatuses, methods, systems, and their respective embodiments disclosed herein facilitate package seal opening and closing. The description of elements in each figure may refer to elements of proceeding figures. Like numbers refer to like elements in all figures, including alternate embodiments of like elements.

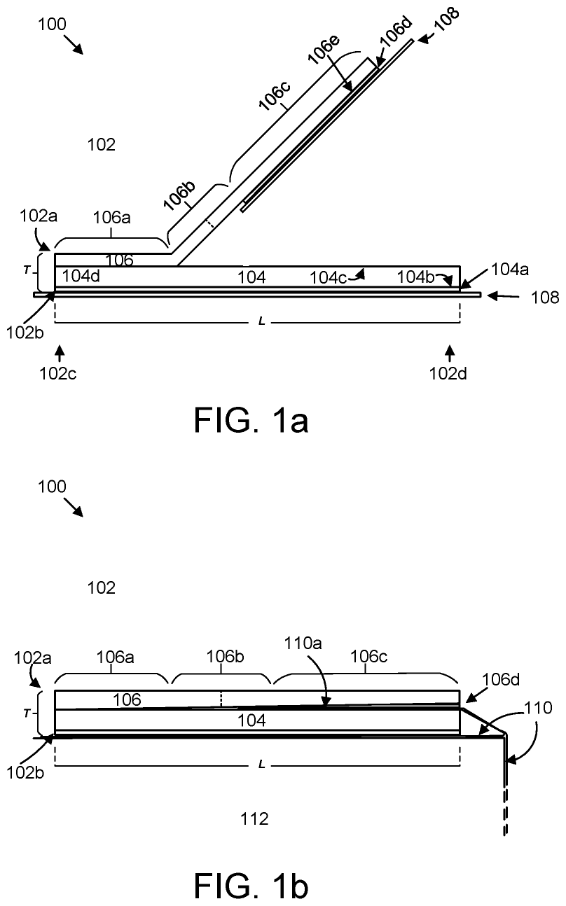

FIG. 1a is a schematic block diagram illustrating a side view of one embodiment of a packaging seal 102. In one embodiment, the apparatus 100 includes a packaging seal 102, a protective layer 104, and a seal layer 106.

The packaging seal 102 includes a height or thickness T with a top surface 102a and a bottom surface 102b, a length L having a proximal end 102c and a distal end 102d, and a width 102e in a direction orthogonal to the length (not shown in the two-dimensional FIG. 1 but would go into/out of the page in three dimensions). One of skill in the art will understand that the packaging seal 102 may vary in size and shape (planar view) and may include a fixed or variable length, a fixed or variable width, a fixed or variable thickness, or a fixed or variable height depending upon the application. For example, the width of the packaging seal 102 may exceed its length L to provide a security seal the entire width of a package.

The protective layer 104 includes an adhesive layer 104a, which substantially covers a bottom surface 104b of the protective layer 104. The protective layer further includes a top surface 104c and a proximal end 104d. In many embodiments, the underside of the adhesive layer 104a may be covered temporarily with a removable film 108. In some embodiments, the adhesive layer 104a may be extended and adhered to a portion of the bottom surface of the seal layer 106. The protective layer may be made from any of various materials including, for example, cardboard, fiber-reinforced cardboard or plastic, plastic coated cardboard, hard plastic, fiber reinforced material designed to resist torsional cutting, etc., or a combination of such materials. The adhesive layer 104a may be made from a variety of adhesive materials, which allow removal of the removable film 108 but which adhere permanently when applied to packaging enclosure materials.

The seal layer 106 includes an anchor portion 106a, a cutting portion 106b, and a flap portion 106c. The anchor portion 106a may be permanently attached to the top surface 104c and a proximal end 104d of the protective layer 104. In the lengthwise direction of the packaging seal 102, the cutting portion 106b extends from the anchor portion 106a to the flap portion 106c. In some embodiments, in the widthwise direction of the packaging seal 102, the cutting portion 106b does not extend as far as the edges of the protective layer 104. The flap portion 106c extends from the cutting portion 106b toward the distal end 102d of the packaging seal 102. The flap portion 106c also includes an adhesive layer 106d, which substantially covers a bottom surface 106e of the flap portion 106c. In some embodiments, the first adhesive layer 104a and the second adhesive layer 106d may have different adhesion properties. The underside of the adhesive layer 106d may be covered with the removable film 108, as described with reference to the adhesive layer 104a of the protective layer 104.

The seal layer 106 may include any of a variety of security labels, tapes stickers, seals, or the like that are commonly used to detect tampering. The materials used in the seal layer 106 must be strong enough to secure the packaging enclosure 110 and withstand normal shipping conditions and thin enough to break the seal layer 106 by cutting, for example, without cutting through the protective layer 104 beneath.

In many embodiments, the protective layer 104 is more resistant to cutting than the cutting portion 106b of the seal layer 106. In one embodiment, the protective layer 104 includes a reinforced portion underlying the cutting portion 106b of the seal layer 106. In some embodiments, the protective layer 104 is thicker in the reinforced portion.

FIG. 1b is a schematic block diagram illustrating a side view of one embodiment of a packaging seal 102 and packaging enclosure 110. The packaging seal 102 is configured to permanently adhere to a packaging enclosure 110 upon removal of the first removable film 108. This can include replacing a broken packaging seal 102 with a new “authorized” packaging seal 102 as discussed regarding several beneficial circumstances below. The bottom surface 106e of the second adhesive layer 106d is configured to permanently adhere to an end portion 110a of the packaging enclosure 110 upon removal of the second removable film 108. The end portion 110a of the packaging enclosure 110 may be originally folded one or multiple times or in various configurations to provide an airtight or watertight packaging seal 102 and such folds may be reused, pulled tight, and re-secured with a new packaging seal 102 to achieve the same airtight or watertight shipping or storage condition.

The materials used in such packaging seals 102 must be strong enough to not be destroyed during shipping and easy enough to unseal, so the user doesn't harm or scratch the product or packaging enclosure 110 when removing, breaking, or cutting the packaging seal 102 or otherwise removing the packaging enclosure 110.

The packaging enclosure may include any readily available material suitable for the given application, for example, a low-density polyethylene plastic bag (LDPE), a polyester film (e.g., Mylar® (Polyethylene Terephthalate)) bag, polyester box, cardboard box, etc. Such packaging enclosures 110 and seals 102 may be designed to prevent dust, humidity, heat, electrostatic discharge, or the like from compromising the packaged product 112 during distribution or storage.

For security and protection purposes, within the production/distribution channel, entities and personnel authorized to open the packaging enclosure 110 may be provided with extra “authorized” packaging seals 102. Such packaging seals may include labels, colors, symbols, or warnings to alert authorized personnel (or the end user) as to where to cut to avoid damaging the package product 112. This enables them to open the packaging enclosure 110 by safely cutting through the cutting portion 106b to break the original packaging seal 102 and then, in the case of the authorized personnel, to apply a new “authorized” packaging seal 102 to the packaging enclosure 110 and re-ship the packaged product 112 in its original packaging enclosure 110 without compromising the integrity of its contents.

As an example, an IT department might be authorized to open, upload software to, and reseal with an authorized packaging seal 102 a packaged computer 112 before delivering the computer 112 to the end user. The embodiments described herein would thus assist the IT personnel to avoid unintentionally scratching the computer when opening the packaging seal 102 and packaging enclosure 110 and then to refold and reseal the packaging enclosure with an authorized packaging seal 102 to avoid compromising the “Faraday” cage of a Mylar® enclosure 110 and to ensure further security during shipping.

Such warnings could also prevent the authorized personnel or end user from unintentionally damaging a product 112 that is loosely enclosed in a packaging enclosure 110. In transit, products, components, or wires may shift or come undone within a loosely packaged enclosure 110 in transit and/or such may be blocked from the end user's view making them susceptible to being cut with scissors or a razor/box knife. The embodiments herein prevent this from happening.

In other applications, the packaging seal 102 and packaging enclosure 110 might tightly enclose the device or may directly abut a surface area of the product 112. This may complicate an attempt to open the enclosure without damaging the product 112, enclosure 110, or seal 102. Indeed, the seal 102 and packaging enclosure 110 may be intentionally designed to be difficult to cut through or remove without compromising the integrity of the seal or packaging enclosure or damaging the product. In such instances, the end user may either haphazardly or even carefully slice through a packaging seal 102 and scratch or damage the enclosed product 112 or included accessories.

Packaging systems, such as those described in the embodiments herein, may be designed to detect tampering or unauthorized access during distribution. Sadly, bad actors might intentionally open the packaging seal 102 or packaging enclosure 110 for nefarious purposes (e.g., install malware). The embodiments described herein may also assist in the case of a product return. An entity may determine if the packaging seal 102 or packaging enclosure 110 has been opened and therefore whether it is getting full value for the returned product 112.

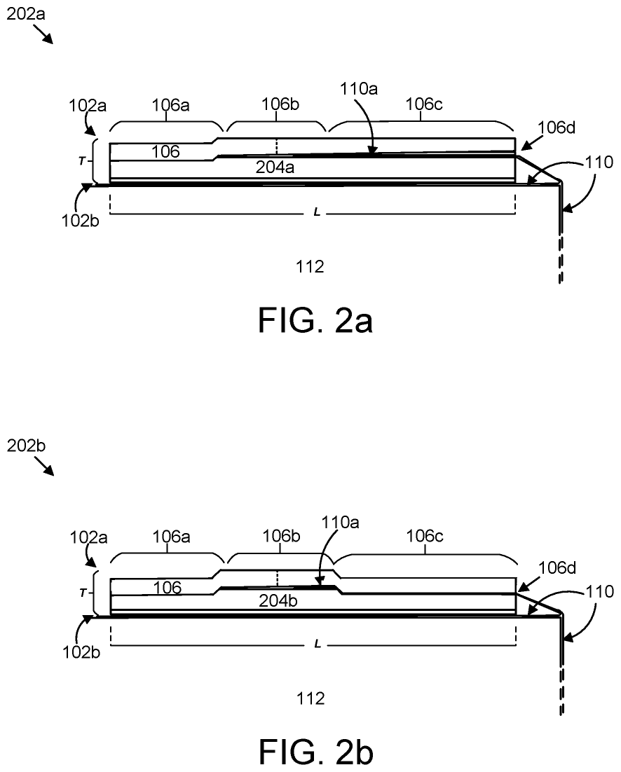

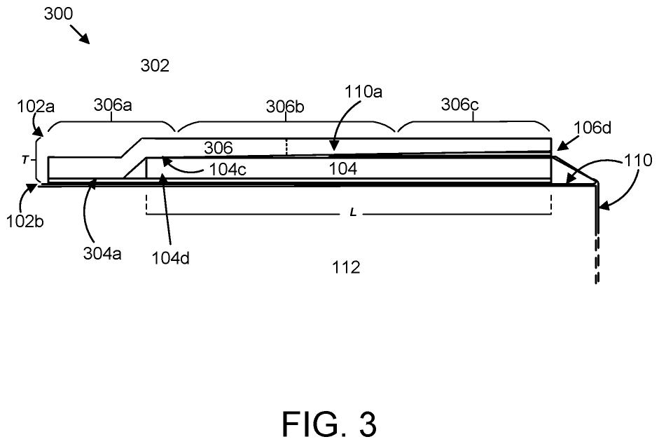

FIG. 2a is a schematic block diagram illustrating a side view of another embodiment of a packaging seal 202a and packaging enclosure 110. Like components in FIGS. 2a, 2b, and 3 are identified using the same numbers as in FIGS. 1a and 1b and a similar description applies here regarding these components. In this embodiment, protective layer 204a includes portions having different thicknesses. The portion of 204a underlying the anchor portion 106a may be of reduced thickness. The portions of 204a underlying the cutting portion 106b and the flap 106c may include, for example, a reinforced material or a thicker material to guard against cutting through the protective layer 204a when cutting through the seal layer 106.

FIG. 2b is a schematic block diagram illustrating a side view of an alternative embodiment of a packaging seal 202b and packaging enclosure 110. In this embodiment, protective layer 204b includes portions having different thicknesses. The portions of 204a and 204c underlying the anchor portion 106a and flap portion 106c may be of reduced thickness. The portion of 204b underlying the cutting portion 106b may include, for example, a reinforced material or a thicker material to guard against cutting through the protective layer 204a when cutting through the seal layer 106. This embodiment provides both an increased visual and tactile identification of where the cutting portion 106b begins and ends. This embodiment may also reduce manufacturing costs.

FIG. 3 depicts a schematic block diagram illustrating a side view of yet another embodiment of system 300, which includes one embodiment of a packaging seal 302 and packaging enclosure 110. Seal layer 306, in this embodiment, includes an anchor portion 306a, which has an extended portion beyond the protective layer 104 in the proximal end direction. The first adhesive layer 304a is also extended to substantially cover a bottom surface of the extended portion of the anchor portion 306a.

The anchor portion 306a of seal layer 306, in one embodiment, may still attach to the top surface 104c and the proximal end 104d of the protective layer 104, as described regarding FIGS. 1a and 1b, and may also permanently attach upon application to the packaging enclosure 110 for added seal anchoring strength. The cutting portion 306b extends from the anchor portion 306a to the flap portion 306c and may be enlarged for an expanded cutting area of seal 302.

The expanded cutting area of seal 302 could also provide more space for labels or warnings to assist authorized personnel or the end user in avoiding unintentionally damaging a product 112 by cutting in the wrong location with scissors or a razor/box knife. In some embodiments, a reinforced or thicker portion of the protective layer 104 underlying the cutting portion 306b may also be expanded to accommodate the expanded cutting area of seal 302.

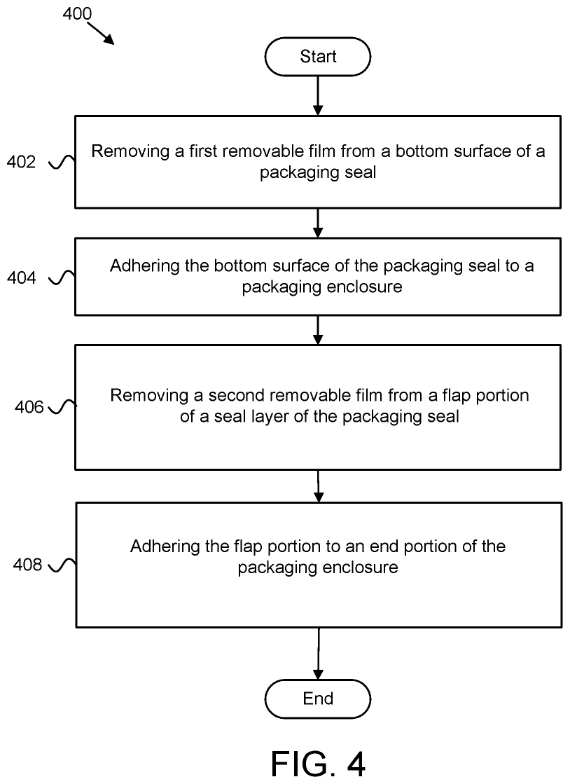

FIG. 4 is a schematic flow chart diagram illustrating one embodiment of a method for applying a packaging seal 102 to a packaging enclosure 110. In some embodiments, the method 400 is performed by an apparatus, such as the packaging seal 102. In other embodiments, the method 400 may be performed by alternative packaging seal apparatuses 202a, 202b, 302, or other designs that use the same principles taught herein.

In one embodiment, the method 400 begins by removing 402a the first removable film 108 from the bottom surface 102b of the packaging seal 102. The method 400 continues by adhering the bottom surface 102b of the packaging seal 102 to the packaging enclosure 110. The method 400 continues by removing 406 the second removable film from the flap portion 106c of the seal layer 106 of the packaging seal 102. The method 400 continues by adhering 408 the flap portion 106c to an end portion 110a of the packaging enclosure 110.

In some embodiments of method 400, the packaging seal 102 includes a protective layer 104 that is more resistant to cutting than the seal layer 106. In one embodiment, a portion of the protective layer 104 includes a reinforced material. In another embodiment, the reinforced portion underlies the cutting portion 106b of the seal layer 106. In some embodiments, the reinforced portion of the protective layer 104 is thicker than a non-reinforced portion of the protective layer 104. In one embodiment, the reinforced portion of the protective layer extends laterally (i.e., in the width direction of the packaging seal 102) beyond the cutting portion 106b of the seal layer 106.

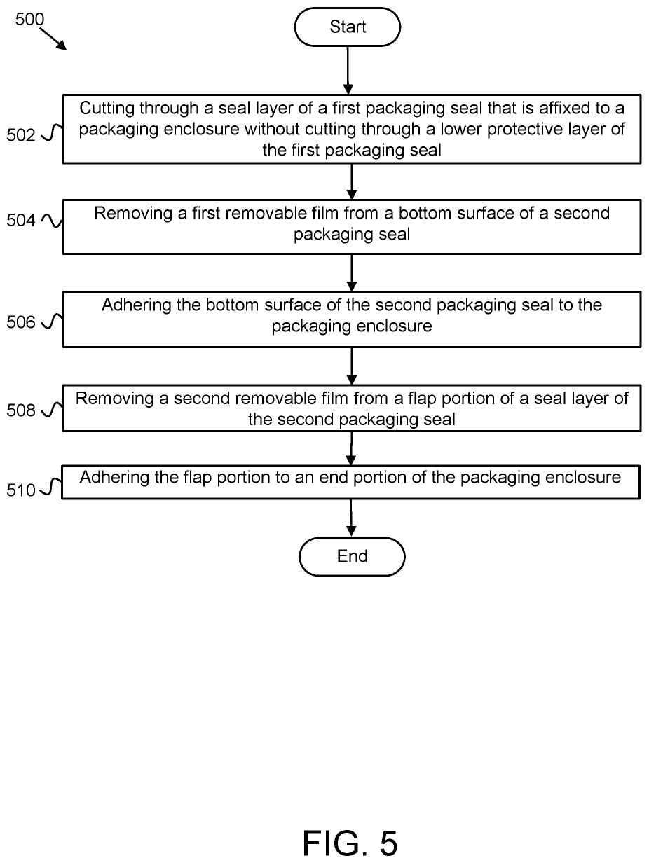

FIG. 5 is a schematic flow chart diagram illustrating one embodiment of a method for breaking one packaging seal 102 and applying another packaging seal 102 to a packaging enclosure 110. During manufacturing, distribution, and storage, this method may be repeated over and over depending upon how many times the packaged product needs to be opened and re-sealed. In some embodiments, the method 500 is performed by an apparatus or multiple apparatuses, such as packaging seals 102. In other embodiments, the method 500 may be performed by alternative packaging seal apparatuses 202a, 202b, 302, or other designs that use the same principles taught herein.

In one embodiment, the method 500 begins by cutting through 502 the seal layer of the first packaging seal 102 that is affixed to the original packaging enclosure 110 without cutting through the lower protective layer 104 of the first packaging seal 102. The method 500 continues by removing 504 the first removable film 108 from the bottom surface 102b of the second packaging seal 102. The method 500 continues by adhering 506 the bottom surface 102b of the second packaging seal 102 to the packaging enclosure 110. The method 500 continues by removing 508 the second removable film 108 from the flap portion 106c of the seal layer 106 of the second packaging seal 102. The method 500 continues by adhering 510 the flap portion 106c of the seal layer 106 of the second packaging seal 102 to an end portion 110a of the original packaging enclosure 110.

In some embodiments of method 500, the packaging seal 102 includes a protective layer 104 having a reinforced portion that is more resistant to cutting than the seal layer 106. In one embodiment, the reinforced portion underlies and extends laterally beyond a cutting portion 106b of the seal layer 106. In another embodiment, the reinforced portion of the protective layer is thicker than a non-reinforced portion of the protective layer 104. In one embodiment, the reinforced portion of the protective layer extends laterally (i.e., in the width direction of the packaging seal 102) beyond the cutting portion 106b of the seal layer 106.

What is claimed is:

1. An apparatus comprising:
a packaging seal having a thickness with a top surface and a bottom surface, a length having a proximal end and a distal end, and a width in a direction orthogonal to the length, further comprising;
a protective layer having a first adhesive layer substantially covering a bottom surface of the protective layer; and
a seal layer having an anchor portion attached to a top surface and a proximal end of the protective layer, a cutting portion extending from the anchor portion to a flap portion; the flap portion extending from the cutting portion toward the distal end of the packaging seal and having a second adhesive layer substantially covering a bottom surface of the flap portion.

2. The packaging seal of claim 1, wherein the protective layer is wider than the cutting portion of the seal layer.

3. The packaging seal of claim 1, wherein a first removable film covers the bottom surface of the packaging seal, and a second removable film covers a bottom surface of the second adhesive layer.

4. The packaging seal of claim 3, wherein the bottom surface of the packaging seal is configured to adhere to a packaging enclosure upon removal of the first removable film and wherein the bottom surface of the second adhesive layer is configured to adhere to an end portion of the packaging enclosure upon removal of the second removable film.

5. The packaging seal of claim 1, wherein the first adhesive layer and the second adhesive layer have different adhesion properties.

6. The packaging seal of claim 1, wherein the packaging seal is a substantially rectangular shape.

7. The packaging seal of claim 1, wherein the protective layer is more resistant to cutting than the cutting portion of the seal layer.

8. The packaging seal of claim 7, wherein the protective layer includes a reinforced portion underlying the cutting portion of the seal layer.

9. The packaging seal of claim 8, wherein the protective layer is thicker in the reinforced portion.

10. The packaging seal of claim 1, wherein the anchor portion has an extended portion beyond the protective layer in the proximal end direction and wherein the first adhesive layer is extended to substantially cover a bottom surface of the extended portion of the anchor portion.

11. A method comprising:
Removing a first removable film from a bottom surface of a packaging seal;
Adhering the bottom surface of the packaging seal to a packaging enclosure;
Removing a second removable film from a flap portion of a seal layer of the packaging seal; and
Adhering the flap portion to an end portion of the packaging enclosure.

12. The method of claim 11, wherein the packaging seal includes a protective layer that is more resistant to cutting than the seal layer.

13. The method of claim 12, wherein a portion of the protective layer includes a reinforced material.

14. The method of claim 13, wherein the reinforced portion underlies a cutting portion of the seal layer.

15. The method of claim 14, wherein the reinforced portion of the protective layer is thicker than a non-reinforced portion of the protective layer.

16. The method of claim 14, wherein the reinforced portion of the protective layer extends laterally beyond the cutting portion of the seal layer.

17. A method comprising:
Cutting through a seal layer of a first packaging seal that is affixed to an original packaging enclosure without cutting through a lower protective layer of the first packaging seal;
Removing a first removable film from a bottom surface of a second packaging seal;
Adhering the bottom surface of the second packaging seal to the original packaging enclosure;
Removing a second removable film from a flap portion of a seal layer of the second packaging seal; and
Adhering the flap portion to an end portion of the original packaging enclosure.

18. The method of claim 17, wherein the packaging seal includes a protective layer having a reinforced portion that is more resistant to cutting than the seal layer.

19. The method of claim 18, wherein the reinforced portion underlies and extends laterally beyond a cutting portion of the seal layer.

20. The method of claim 18, wherein the reinforced portion of the protective layer is thicker than a non-reinforced portion of the protective layer.
